(19) United States
(12) Patent Application Publication
(10) Pub. No.: US 2003/0073559 A1
(43) Pub. Date: Apr. 17, 2003

(54) Apparatus and method for longitudinal folding

(76) Inventor: Balbir Singh, Media, PA (US)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 10/161,009

(22) Filed: May 31, 2002

Related U.S. Application Data
(62) Division of application No. 09/620,165, filed on Jul. 20, 2000.

(51) Int. Cl. B31F 1/10

(52) U.S. Cl. 493/424

(57) ABSTRACT

An apparatus and method is disclosed useful for folding materials, particularly fabrics that are fragile such as medical gauze. The apparatus in its simplest embodiment comprises a roller and a disk which is in communication with the roller. In operation, the material to be folded first is drawn between the roller and disk and then drawn against the disk to form a fold.

### BACKGROUND OF THE INVENTION

1. Field of the Invention

This invention is concerned with a method and apparatus for the longitudinal folding of materials, in particular, the longitudinal folding of fabric such as gauze.

2. Related Art

There are several techniques known for accomplishing the folding of materials in the longitudinal direction.

U.S. Pat. Nos. 4,349,185 and 5,147,276 describe a folding technique which generally may be termed the “plow” method of folding. In the plow method, a fabric streamer is drawn over a stationary plow with edges inclined at some angle to the flow direction. As the web travels over the plow it folds over along a line which is parallel to the flow direction. The plow is also referred to as a fold-pan, a former, or just guide bars. The web must be pulled over the plow to form the folds. Consequently, a tension develops which could be detrimental to bulk (thickness) or stretch (elasticity). As such this method is used primarily for flexible materials, such as papers (tissue, newsprint), nonwovens, gauzes, films, flexible laminates, etc. Any severing of the web into discrete elements must be performed after the folding operation.

U.S. Pat. Nos. 4,211,396 and 4,272,066 describe a folding technique which generally may be termed as the “plunger” method of folding. In the plunger method a fabric is first severed into short elements and positioned over a slot. This is an intermittent process: the element must stop prior to folding. A reciprocating plunger or a blade pushes the element through the slot to bi-fold it. In other designs, the slot could be substituted with a nip formed by a pair of nipped rollers or conveyors which take away the element as it is folded. This method is primarily used for stiffer materials (cardboard, heavier laminates) or bulkier webs (sanitary disposables, foams, bulky medical sponges).

U.S. Pat. Nos. 3,973,373 and 4,190,243 describe folding techniques which use a combination of both the foregoing described plow and plunger methods.

Another folding technique may be accomplished through the use of air knives and/or air jets. This technique may be used for highly stretchable webs or fabrics. In this method air knives impinge the web from the sides as it flows in a straight line, and fold the sides over. It is used for webs where bulk as well as stretch must be preserved. This method is continuous like the plow method, but does not require tensioning the web to achieve folding. Also, the web is not pressed down on any edge or surface during folding. However, because of instability associated with blowing air, this method can result in large waste of product and down-time of equipment. Examples of materials used with air folders include high bulk surgical sponges.

The foregoing folding methods have certain disadvantages particularly when the material to be folded is a highly creped or compacted (i.e., capable of stretching up to 50% from the material's unstreched condition) and spongy (i.e., in terms of high compressibility in the fabric thickness direction) material such as absorbent medical gauze. Such a material is too fragile to be folded using the plow technique because the inherent tension that is placed on the material during the folding process deforms the compactness of the gauze. The discontinuous nature of the plunger method of folding is due to this method's reciprocating action and is a disadvantage as compared to continuous methods of folding. Since the fabric must be severed prior to folding, the plunger method is applicable for sheets of short length, such as napkins and wipes, but would not be practical for products of longer lengths such a surgical bandages and rolled sanitary products.

Finally, some disadvantages of folding with air knives include the difficulty in keeping the method difficult due to fouling of nozzles or disruptions in maintaining a constant uniform air pressure) and maintaining the intended fold which tends to be unstable and often fold on either side (i.e., weave in and out) of the intended fold lines.

One solution to the disadvantages of the prior methods is provided by the invention hereinafter described.

### BRIEF DESCRIPTION OF THE DRAWINGS

FIG. 1 depicts the folding of a material through the creasing and draping of the material by means of a roller and a disk according to one embodiment of the present invention.

FIG. 2 depicts the creasing and draping of a material to be folded by means of a thin disk intruding into a slightly wider groove in a drive roller according to one embodiment of the present invention.

FIG. 3 shows a schematic of the device folding material longitudinally in two consecutive steps to achieve three folds of fabric according to another embodiment of the invention.

FIGS. 4A-4C show a detailed view of the roller and disk assembly for the device depicted in FIG. 2.

FIGS. 5A-5C show the folding steps for the device depicted in FIG. 2.

FIGS. 6A-6C show the folding steps for the device depicted in FIG. 3.

### SUMMARY OF THE INVENTION

One embodiment of present invention relates to a device and a method for folding materials comprising:

a) a primary roller for receiving a material to be folded;

b) a primary disk in communication with said roller for creasing and folding said material as said material travels from said roller to said disk.

In other embodiments, the primary roller further comprises a notch and said primary disk is in communication with said notch and said communication including said primary disk being biased to be in contact with said notch.

Another embodiment of the invention relates to any of the foregoing embodiments further comprising a secondary roller and a secondary disk wherein said secondary roller comprises a notch and said secondary disk is in communication with said notch of the secondary roller and wherein the secondary roller receives the folded material from the primary disk and the material to be further folded travels from said secondary roller to said secondary disk.

Another embodiment relates to any of the foregoing embodiments further comprising a feed roller and a pair of fold rollers wherein said feed roller aligns the material to be folded with said primary roller and said pair of fold rollers receives the material from either of said primary or secondary disks to press the material to complete the fold.

The method of the present invention relates to a method for folding a material comprising the steps of

a) drawing the material between a primary roller and a primary disk to create a crease; and

b) further drawing the material sufficiently around said primary disk to form a fold.

Advantages of the present invention include (i) continuous and essentially tensionless folding with little loss of compaction or creping of fragile materials; (ii) creasing of the material to be folded only at the folding line which helps to maintain minimal bulk loss when the material is a bulky gauze; (iii) precise control of the fold line which is difficult to achieve by the air-folding process; and (iv) reduced off-spec product which results in less waste and downtime of other machines or devices that may be upstream or downstream of the folding device.

### DETAILED DESCRIPTION OF PREFERRED EMBODIMENTS OF THE INVENTION

Embodiments of the present invention and the advantages thereof are best understood by referring to the following descriptions and drawings, wherein like numerals are used for like and corresponding parts of the drawings.

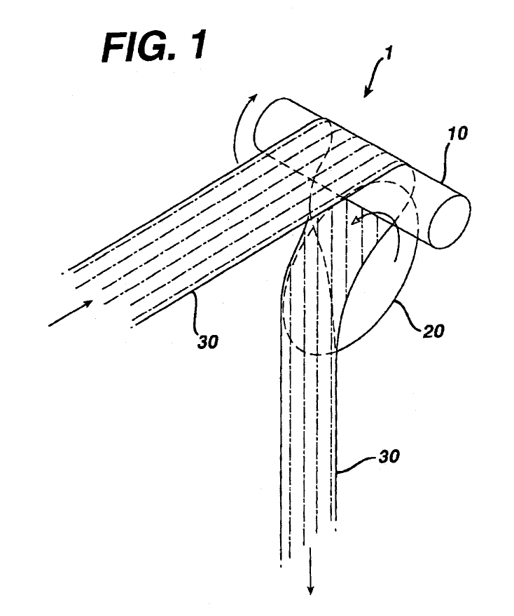

FIG. 1 is a diagram illustrating a device 1 for the longitudinal folding of material such as fabric in accordance with an embodiment of the present invention. As used herein, the term “longitudinal” is intended to describe folding along the length of the material to be folded. Device 1 includes a primary roller 10 and a primary disk 20. Both roller 10 and disk 20 are rotatably mounted and are in communication with one another. As used herein, the term “communication” is intended to cover the instances where roller 10 and disk 20 are in actual contact with one another or are separated by a small clearance which is sufficient to pass the material to be folded and yet accomplish a folding step.

In operation, the material to be folded 30 is first drawn about roller 10 and then is drawn about disk 20 thereby accomplishing a fold. Disk 20 functions to provide a point of contact with material 30 at which point of contact a crease is made and a fold is initiated which eventually results in a completed fold as material 30 is further drawn around the disk 20.

Either roller 10 and/or disk 20 can be driven or can be free spinning. An example when the both roller 10 and disk 20 are free spinning can occur when device 1 forms part of a continuous process and the material to be folded 30 is driven by a downstream source from device 1. As a stand-alone device, it is preferred that roller 10 provide the mechanism for pulling the material to be folded 30 (i.e., function as a “drive” roller) and disk 20 is free spinning but in contact with rotating roller 10 so that disk 20 can rotate from frictional contact with roller 10. Thus, roller 10 and disk 20 act to drive material 30 by nipping material 30 between roller 10 and disk 20. The folding of material 30 is achieved naturally as material 30 flows over disk 20 under the action of gravity. Alternately depending on the type of fabric to be folded, disk 20 can be driven (i.e., function as a “drive” disk) in addition to having roller 10 being driven. Having both roller 10 and disk 20 driven may arise in the case where the material to be folded is a slippery fabric or where the material to be folded is not in actual contact between roller 10 and disk 20 as in such instance, there would be no contact between roller 10 and disk 20. Furthermore, in any embodiment of this invention, optional guide bars and/or plates (not shown) may be strategically placed to help in the folding of less drapeable or flexible (i.e., non-conforming) materials.

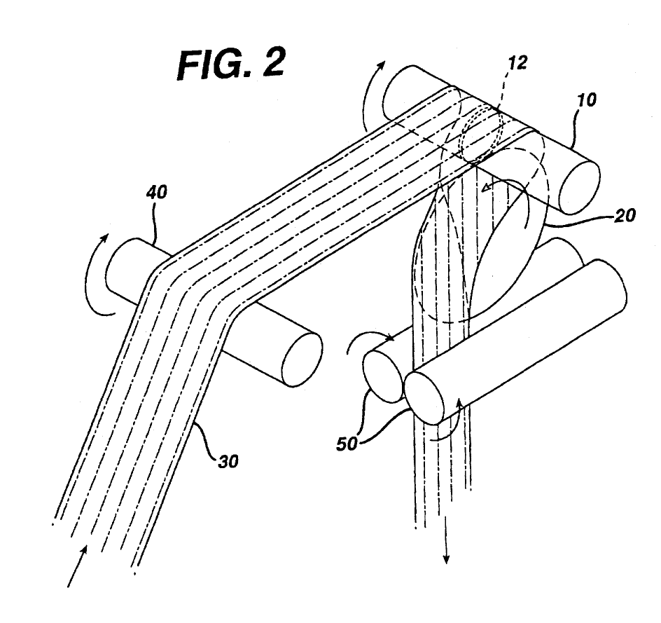

FIG. 2 depicts another embodiment of the present invention. In particular, FIG. 2 depicts a device containing in addition to primary roller 10 and primary disk 20, feed roller 40 and a pair of fold rollers 50. Primary roller 10 is also depicted to have a notch 12 which is in communication with the edge of disk 20.

In operation the material to be folded 30 is drawn over feed roller 40 which helps to align and provide the proper tension in material 30 before passing over to the primary roller 10. Once material 30 is in contact with roller 10, it is drawn back around roller 10 and between disk 20 wherein material 30 is creased through the contact of the edge of disk 20 and material 30 as material 30 is pinched into notch 12. Material 30 continues along disk 20 where the material 30 passes between fold rollers 50 after passing over disk 20. Fold rollers 50 function to press together the two surfaces of material 30 coming off disk 20 to more tightly complete the fold.

Any of the rollers 10, 40, or pair of rollers 50 and disk 20 can be driven to allow for material 30 to be folded. For example, only fold rollers 50 may be needed to provide the necessary drive, with rollers 10, 40 and disk 20 being free spinning. Desirably, disk 20 remains free-spinning while roller 10 and 40 and rollers 50 are driven. But as will be appreciated by one skilled in the art upon reading this disclosure, any combination of driven rollers and/or disk may be used depending on the material to be folded. In particular, it may be most desirable when material 30 is a fragile gauze-like fabric, that roller 10, roller 40 and rollers 50 are driven and disk 20 is free spinning.

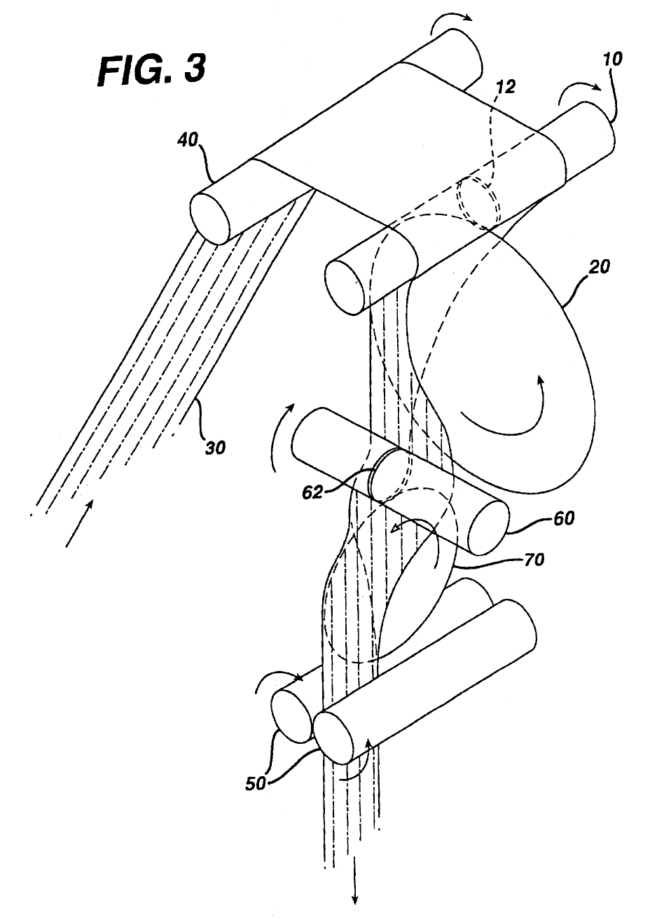

FIG. 3 depicts yet another embodiment of the invention wherein another fold is achievable over the device of FIG. 2. Specifically, FIG. 3 contains secondary roller 60 and secondary disk 70. Further, secondary roller 60 is depicted to contain a notch 62. However, it should be noted that while FIG. 3 depicts notch 62 in roller 60 and notch 12 on roller 10 that notch 12 and 62 are optional and may not be needed for proper folding depending on variables such as the nature of material 30.

In operation, the device of FIG. 3 accepts material 30 over feed roller 40. Material 30 then travels over and around roller 10 wherein material 30 is creased by the edge of disk 20 as disk 20 contacts roller 10 at notch 12. After being creased at notch 12, material 30 is drawn further along disk 20 completing the formation of a first fold. After leaving disk 20, material 30 then is drawn around secondary roller 60 wherein material 30 is creased by the edge of disk 70 as disk 70 contacts roller 60 at notch 62. After being creased at notch 62, material 30 is drawn further along disk 60 completing the formation of a second fold. After leaving disk 70, material 30 then passes between fold rollers 50 to more tightly complete the fold.

As with the device depicted in FIG. 2, the device depicted in FIG. 3 can be driven by any combination of rollers and/or disks depending on the nature of material to be folded. Thus, if it is possible that material 30 can be sufficiently driven only off of fold rollers 50, then roller 40, roller 10, roller 60 and disks 10 and 70 can be free spinning. However, if material 30 is fragile-like gauze, then it is preferred that roller 40, roller 10, roller 60 and rollers 50, be driven and disks 20 and 70 be free spinning. Also if material 30 is a slippery or silky type of fabric to be folded, then it may be necessary that the disks be driven as well.

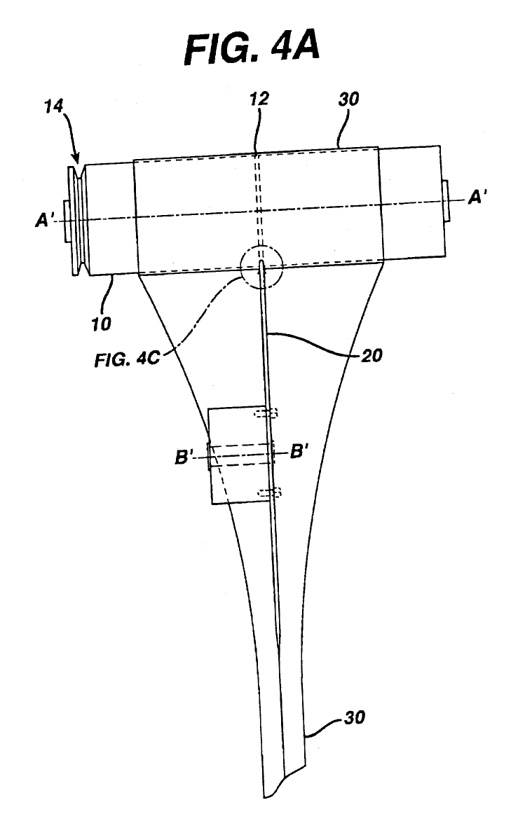

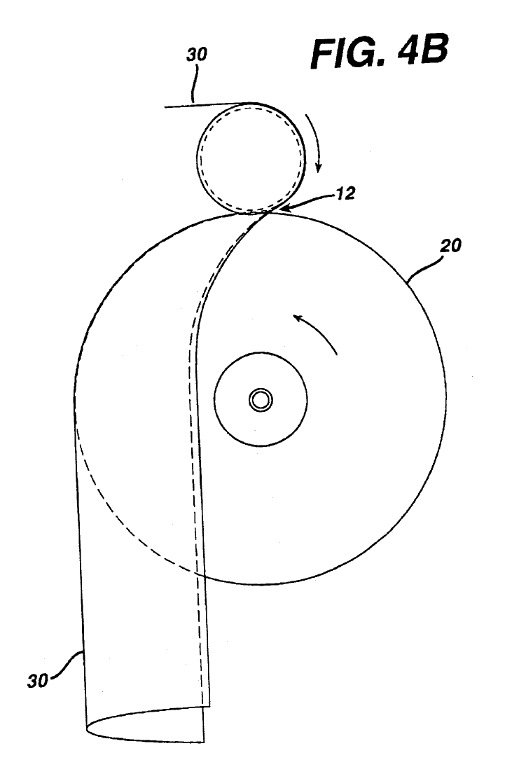

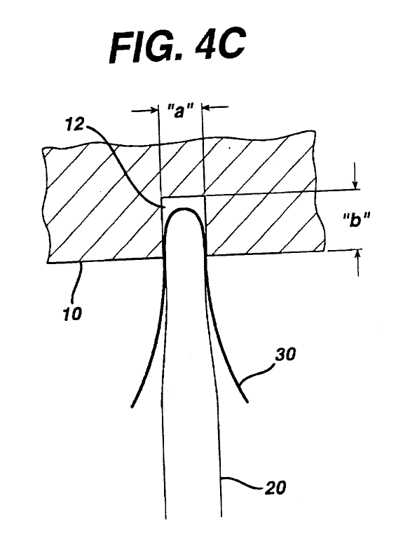

FIGS. 4A-4C depict a preferred embodiment of this invention as it relates to the operation and communication of roller and disk. In this instance, although only depicted for primary roller 10 and primary disk 20, it should be noted that this embodiment is applicable to any roller and disk that are in communication with each other (e.g., secondary roller 60 and secondary disk 70, or if additional roller/disk assemblies are needed for increasing the number of folds). FIG. 4A depicts a front view of primary roller 10 containing notch 12 and pulley 14 which receives a belt (not shown) for rotating (driving) primary roller 10 around axis A′-A′. Primary disk 20 rotates freely (i.e., free-spinning) about axis B′-B′ by virtue of disk 20's communication (i.e., frictional traction contact) with primary roller 10. More specifically, Fig. disk 20's communication (i.e., frictional traction contact) with primary roller 10. More specifically, FIG. 4B (which is a side view of FIG. 4A) shows that as primary roller 10 rotates clockwise, the material 30 being drawn along primary roller 10 is creased at notch 12 as disk 20 rotates counter-clockwise about axis B′-B′. As material 30 is further drawn along disk 20 from notch 12, material 30 is draped along both sides of disk 20 with the edge of disk 20 maintaining the crease formed at notch 12. As material 30 leaves disk 20, the desired fold is completed.

FIG. 4C depicts an expanded view of notch 12 and its communication with the edge of disk 20. Specifically, material 30 is creased at notch 12 by virtue of material 30 being pinched or nipped between notch 12 (of width dimension “a” and height dimension “b”) and the edge of disk 20. As would be apparent to one skilled in the art, the “a” and “b” dimension of notch 12 should be sized to account for the thickness of material 30 and the thickness of the edge of disk 20, which edge may be tapered as shown in FIG. 4C.

The location where a disk communicates with a roller (or a notch in case a notch is employed) may be at any point along the roller. For example, for a simple ½ fold, the point of communication or location of the notch would be at the midpoint of the roller.

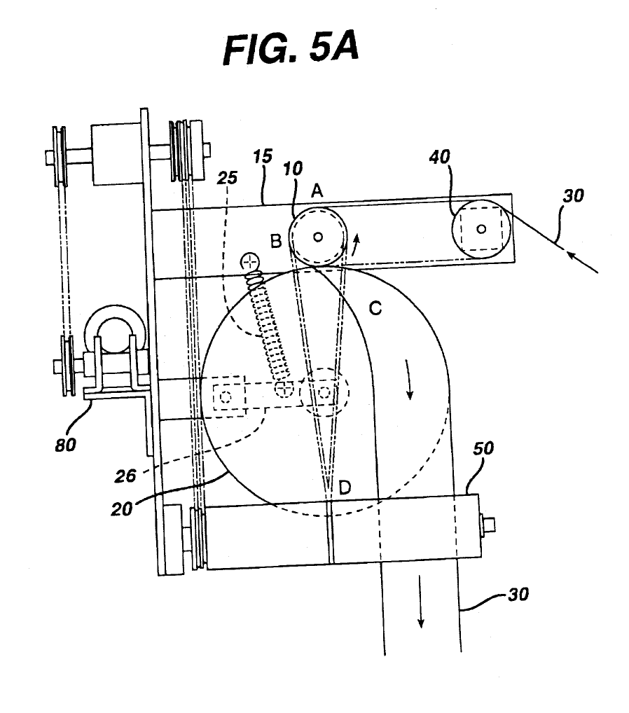

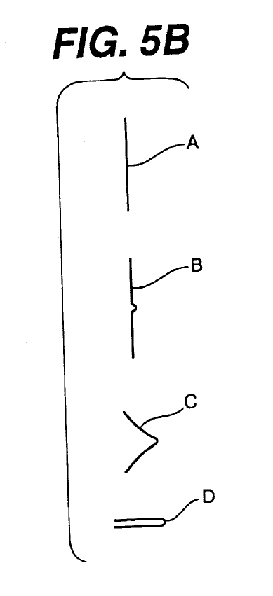

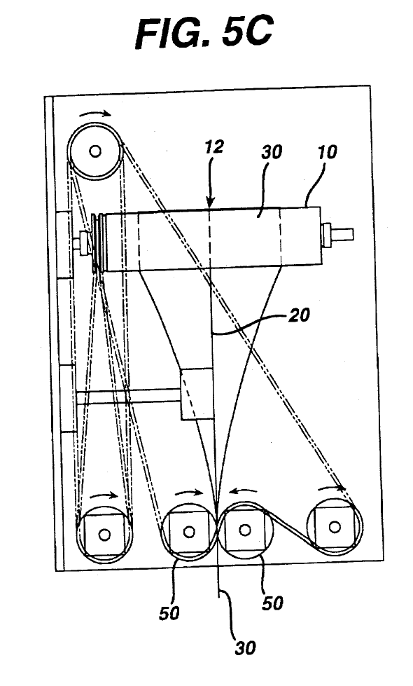

FIGS. 5A-5C depict an embodiment wherein a simple ½ fold is accomplished. Specifically FIG. 5A depicts a side view of the device; FIG. 5B depicts the folding steps A-D corresponding to the points A-D along which material 30 travels as shown in FIG. 5A; FIG. 5C shows a front view of the device.

Referring to FIG. 5A, incoming material 30 passes over feed roller 40 and then travels to primary roller 10 at point A. Material 30 is creased at point B where disk 20 contacts primary roller 10 at notch 12 which is located at the midpoint of roller 10 (more clearly shown by referring to FIG. 5A in conjunction with FIG. 5C). At this point, material 30 is creased as shown in FIG. 5B. Referring back to FIG. 5A and FIG. 5B, a fold of material 30 is initialed at point C and is completed at point D as material 30 passes through fold rollers 50.

Other features shown in FIGS. 5A and 5B that are noteworthy are the biasing of disk 20 to roller 10 by use of spring 25. As noted in earlier discussion, when disk 20 is in direct contact with roller 10, such communication is achieved by biasing disk 20 to roller 10. As depicted in FIG. 5A, spring 25 biases disk 20 by pulling the center of disk 20 toward roller 10. This may be accomplished by connecting one end of spring 25 to support member 26 (which supports disk 20 around its axis of rotation) and the other end of spring 25 to support member 15 (which supports primary roller 10 around its axis of rotation). In the case when roller 10 and disk 20 are separated by a small clearance (not shown), support member 26 is rigidly held and the biasing spring 25 is not required. FIG. 5A and FIG. 5B further depict motor 80 which through a series of pulleys and belts drive the various rollers. Note, some pulleys are an integral part of the rollers in order to accomplish the drive mechanism while other pulleys are not associated with any particular roller but are needed to complete the belt circuit. Finally actual belts are shown in phantom (broken lines). Also, while not shown, the disks may also be driven by means of belts similarly to the manner in which the rollers are driven.

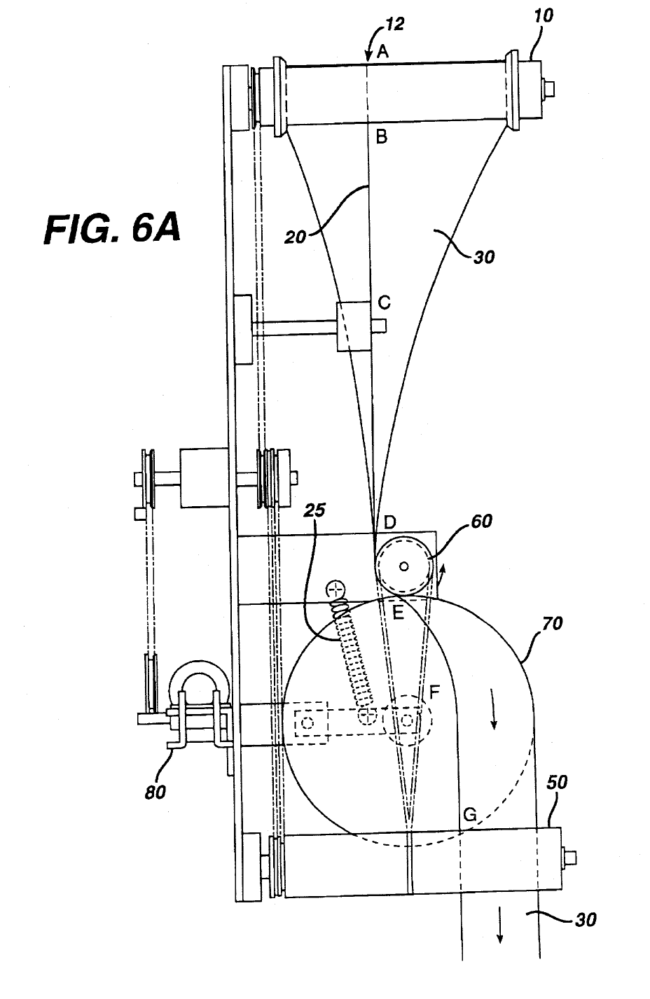

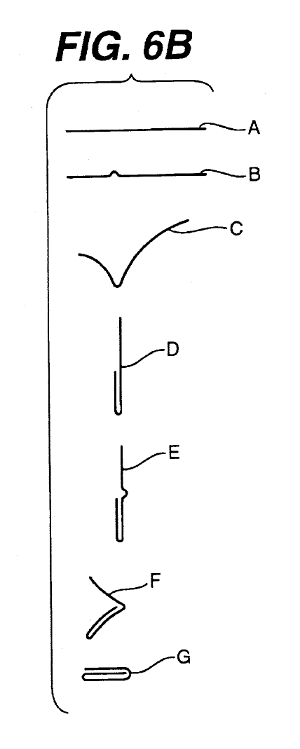

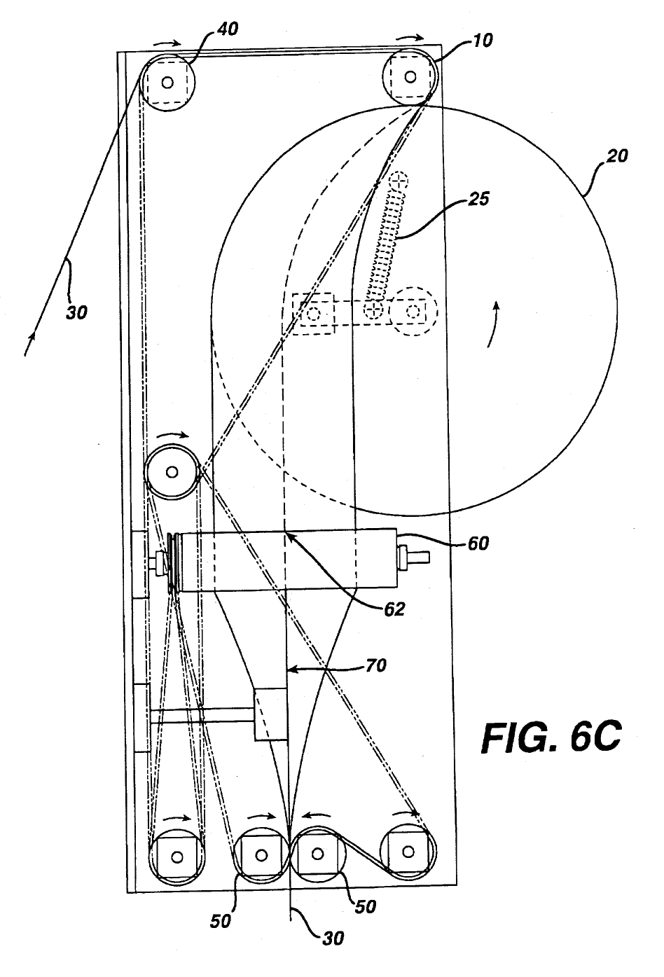

Another embodiment demonstrating the flexibility of the invention in achieving multiple folds and multiple folding locations is shown in FIGS. 6A-6C. Operation of this embodiment is the same as for the device as shown in FIG. 3 and the same description is incorporated herein by reference. FIGS. 6A-6C outline points A-G in achieving two folds which result in material 30 having three plies. Please note that depending on the number of plies material 30 may have before being folded, this embodiment of the invention is capable of achieving three (3) times the number of folds from that starting material. For example, a two-ply starting material will result in a six-ply product, a three-ply starting material will result in a nine-ply product, etc. Referring back to FIGS. 6A-6B, point A refers to material 30 contacting primary roller 10 before being creased. At point B, material 30 is creased not at the midpoint of roller 10, but at a location that is approximately ⅓ of the distance across roller 10. The first fold is initiated at point C and the first fold is completed at point D. Thus, the nature of the first fold is such that only ⅓ of the starting material 30 is folded back against itself. From point D, material 30 transitions to secondary roller 60 and at point E, material 30 is creased for a second time at notch 62. This crease is done at the midpoint of secondary roller 60 (which corresponds to the original ⅔ point of originally received material 30). As material 30 is drawn across secondary disk 70, the second fold is initiated at point F and is completed as the material passes through fold rollers 50 at point G.

In yet another embodiment (Fig. not included), the notch as depicted in FIG. 6A could be placed at the midpoint of primary roller 10 so that material 30 is folded in ½ by primary roller 10 and primary disk 20. In this arrangement, material 30 will be quarter-folded by secondary roller 60 and secondary disk 70. Thus, the location of the notch on the rollers will set the fold arrangement of folded material. In the foregoing case, a 2-ply starting material will result in an 8-ply product. Various off-folded products, in which the edges of material 30 do not overlap after folding, can be produced by strategically locating the notch on the rollers associated with the corresponding disks.

As with FIGS. 5A-5C, FIGS. 6A-6C also depict biasing springs 25 which bias the primary disk 20 and the secondary disk 70 to their respective rollers. Also depicted is motor 80 which drives the various belts and pulleys to rotate and drive rollers 40, 10, 60, and 50 while disks 20 and 70 rotate freely about their respective axis driven by the contact with primary roller 10 and secondary roller 60, respectively.

The device and method of this invention may be further cascaded with additional pairs of roller and disk assemblies to create additional folds. For example, a tertiary roller and tertiary disk may be employed to make an additional fold, a quaternary roller and quaternary disk combination may be added for yet another fold, etc.

In operation, material 30 may be comprised of any suitable substance of sufficient flexibility or capability of being draped (i.e., drapeability or conformability) as required by the creasing and folding steps of the device of this invention as disclosed herein. Examples of suitable materials include but are not limited to paper, woven and non-woven fabrics or cloths, foams, sponges, films, or flexible laminates, particularly fragile fabrics or cloths such as medical gauze, creped paper, thin foams, or thin sponges.

Although the present invention and its advantages have been described in detail, it should be understood that various changes, substitutions, and alterations may be made therein without departing from the spirit and scope of the present invention as defined by the appended claims.

What is claimed is:

1. A folding device comprising:
a) a primary roller for receiving a material to be folded;
b) a primary disk in communication with said roller for creasing and folding said material as said material travels from said roller to said disk.

2) The device of claim 1, wherein said primary roller further comprises a notch and said primary disk is in communication with said notch.

3) The device of claim 2, wherein said primary disk is biased to be in contact with said notch.

4) The device of claim 3, wherein said disk is normal to said primary roller.

5) The device of claim 1, wherein said primary roller is a drive roller and said primary disk is a free-spinning disk.

6) The device of claim 5, wherein said primary disk is a drive disk.

7) The device of claim 5, wherein said primary roller further comprises a notch and said primary disk is in communication with said notch.

8) The device of claim 7, wherein said disk is biased to be in contact with said notch.

9) The device of claim 8, wherein said disk is normal to said roller.

10) The device of claim 1, further comprising a feed roller and a pair of fold rollers wherein said feed roller aligns the material to be folded with said primary roller and said pair of fold rollers receives the material from said primary disk to press the material to complete the fold.

11) The device of claim 10, wherein said primary roller further comprises a notch and wherein said primary disk is in communication with said notch.

12) The device of claim 11, wherein said disk is biased to be in contact with said notch.

13) The device of claim 12, wherein said disk is normal to said primary roller.

14) The device of claim 13, wherein said fold rollers are drive rollers and said disk is a free-spinning disk.

15) The device of claim 14, wherein said primary roller is a drive roller.

16) The device of claim 15, wherein said feed roller is a drive roller.

17) The device of claim 7, further comprising a secondary roller and a secondary disk wherein the secondary roller comprises a notch and said secondary disk is in communication with said notch of the secondary roller and wherein the secondary roller receives the folded material from the primary disk and the material to be further folded travels from said secondary roller to said secondary disk.

18) The device claim 17, wherein both disks are biased to be in contact with their respective rollers.

19) The device of claim 18, wherein both of said disks are free-spinning and are normal to their respective rollers.

20) The device of claim 19, further comprising a feed roller and a pair of fold rollers wherein said feed roller aligns the material to be folded with said primary roller and said pair of fold rollers receives the material from said secondary disk to press the material to complete the fold.

21) The device of claim 20, wherein said fold rollers are drive rollers.

22) The device of claim 21, wherein said secondary roller is a drive roller.

23) The device of claim 22, wherein said primary roller is a drive roller.

24) The device of claim 23, where said feed roller is drive roller.

25) A method for folding a material comprising the steps of
a) drawing the material between a primary roller and a primary disk to create a crease; and
b) further drawing the material sufficiently around said primary disk to form a fold.
